(19) United States
(12) Patent Application Publication
(10) Pub. No.: US 2017/0202327 A1
(43) Pub. Date: Jul. 20, 2017

(54) PROTECTIVE CREDIT CARD COVER

(71) Applicant: KENDRA WATKINS, AMARILLO, TX (US)

(72) Inventor: KENDRA WATKINS, AMARILLO, TX (US)

(21) Appl. No.: 15/406,720

(22) Filed: Jan. 15, 2017

Related U.S. Application Data
(60) Provisional application No. 62/279,634, filed on Jan. 15, 2016.

(51) Int. Cl. A45C 11/18; B42D 25/29

(52) U.S. Cl. CPC A45C 11/182; B42D 25/29

(57) ABSTRACT

A protective credit card cover apparatus that hides confidential information in a credit card, but still allows a credit card transaction to commence. The apparatus has a front side that protect a credit card's front side, a back side that protects a credit cards back side. It achieves this by having visible as well as opaque sections. The apparatus has adhesive section or sections that prevent the credit card from falling out of the apparatus and secures the credit card in place.

### CROSS-REFERENCE TO RELATED APPLICATIONS

This application claims the benefit of and priority to provisional application No. 62/279,634.

### STATEMENT REGARDING FEDERALLY SPONSORED RESEARCH OR DEVELOPMENT (IF APPLICABLE)

Not applicable.

### REFERENCE TO SEQUENCE LISTING, A TABLE, OR A COMPUTER PROGRAM LISTING COMPACT DISC APPENDIX (IF APPLICABLE)

Not applicable.

### BACKGROUND OF THE INVENTION

1. Field of the Invention

The present invention is in the field of identity protection devices. While using credit cards, it is important to protect sensitive information on said cards. This invention is an improved device having concealing surface parts to protect a user's sensitive and confidential information.

2. Description of Related Art

It is known in the art that credit cards, also referred to as wallet cards, are prone to theft. However, stealing the credit card is not necessary to propagate theft of services and to make unauthorized transactions. Users have tried to protect their information by using alternate means to charge for goods such as cash or checks.

However, in today's age, where credit card use is prevalent, a user is forced to use credit card technology in certain situations. Because of this a user must protect his or her card information. The use of credit cards is everywhere in financial transactions.

Further, credit cards do not vary much in size and shape, allowing an invention to protect the user to be created with much uniformity. A credit card or as referred as a wallet card by others, is usually rectangular and flat, comprised of a magnetic strip to read electronic data, and has various information embossed on the card such as name, security numbers, credit card number, and expiration date of the card.

Due to recent changes in technology, credit cards or wallet cards also have embedded chips inside that are used for further security. Additional information is also on the card such as the bank that is extending credit, place for user to sign the card, holograms, important phone numbers, and other identification material.

Each credit card is given a unique identification or card number. The number is used to transact business. It is imperative to protect the credit card information so that another user does not use the card, thereby using the money of the authorized user or owner.

To give a brief description of the need it is important to understand how many residents of the United States are affected by fraudulent credit card transactions and credit card fraud. In the United States, millions of victims are harmed by credit card fraud and identification theft. It is estimated that between four to six million people have suffered from credit card fraud. The amount that is lost by the industry is interpreted differently. The Federal Trade Commission, also commonly referred to as just the FTC, has found that in 2014 about 332,646 identity thefts have occurred and 276,662 imposter scams have taken place. This invention is necessary to curb such high results of fraud.

Credit card companies report billions in losses every year due to credit card fraud. It would indeed be beneficial for a method and apparatus to protect a user's information while allowing the credit card or wallet card to function properly.

Some protective devices already made try to protect the card information but their inventions are costly and the card may still be removed by a person intending on committing fraud. The present invention focuses on a cheap way to protect cards and a permanent solution.

Credit cards generally have a sequence of numbers that are unique to an individual card holder. The same information may be swiped by the magnetic strip in the card without disclosing to an individual who is receiving the card all of the numbers. Additionally, due to the prevalence of credit card chips that is now a requirement, the same user account or credit card information may be provided by the credit card chip. By protecting this information as well as other parts of a credit card information, the user will restrict fraud because the fraudster will not have complete information to commit fraud.

During a normal transaction, the cardholder will give the credit card or wallet card to a third party to facilitate the transaction. The third party, usually a seller or seller's employee, will swipe the card using the electronic magnetic strip on the upper portion on the back of the card and enters a validation code in the back such as a pin and also expiration date. Some cards have further information that may need to be entered.

When the cardholder passes a card to the seller, the cardholder is at risk of losing the cardholder's confidential and private information contained on the credit card. After the transaction is complete, the seller returns the card back to the buyer and requires a signature. The signature is not required by some merchants making small transactions to save time, such as fast-food restaurants. However, the transaction could be conducted without the entire sensitive information showing such as the embossed credit card numbers, which is why the present method and apparatus are important.

Credit card fraud can frequently occur in restaurants, bars, lounges, airports, hotels, fast food places, coffee shops, car rental facilities, or other places where the credit card is left in open spaces when a fraudster comes to take the credit card information. It is common for the waitress in a restaurant to leave a card unattended if her attention is required at other places before coming back to charge the card. Also, unfortunately, there are times when a person trying to commit fraud is an actual employee of the seller. This invention benefits not only the cardholder but sellers because the seller will not have to deal with fraudulent transactions and protects seller from having to take the loss on the transaction. With the present method and apparatus in this application, both the cardholder and the seller will be able to confidently facilitate transactions without worrying about fraud.

In some products, fraud can still occur because a person is able to easily remove a sheath or a credit card cover and put back the card in the sheath or cover as if it had been untouched. In other cases, the credit card cover is too thick and uncomfortable to be carried in a wallet or purse, which lowers the desire to carry a credit card protective device. Further, credit card cases could be expensive and a user may not be able to buy enough to protect all of the user's credit cards.

The damages that may result in the cardholder being liable for the amount of the credit card fraud that occurred if the user can not provide the correct information about card loss to the credit card company. The present apparatus protects against such losses by both the user and credit card companies.

Another important aspect about protecting a credit card is to protect the user from having to show the type of card being used. Some cards such as the “Black Card” carry significant balances that would draw the attention of a person who wants to take the credit card or wallet card information due to the fact that a higher limit card being used will draw less attention to the fact that it was used. Eventually, if undiscovered, a user might actually pay for the transaction that was in reality a fraudulent transaction without realizing it. Something worse may be a fraudulent transaction that is considered a “high-value” fraud. In larger fraudulent transactions, i.e. a high-value fraud, a credit card company may be less reluctant to charge back the amount until it fully understands the situation; this leaves a cardholder with several months of uncertainty until it is finally proven that the card was not part of a valid transaction. This may also leave a credit card user with a lower balance to make purchases, which is a detriment that may create a nuisance in everyday life.

The method and apparatus in this application will allow a user to customize the cardholder with various designs and can directly print designs on the cardholder if the user desires. The custom printing method for a credit card or wallet card is unique and desirable to users.

In the computer age, identity theft is becoming more and more prevalent. Victims do not find out about the theft until months after it has occurred. In such cases, the present method and apparatus would help the consumer to protect against fraud by protecting a user's information before theft can occur.

The current devices, methods, or apparatuses do not protect the consumer to a degree the present method and apparatus in this application do because they lack the security, cost savings, and user friendliness.

There is a need, recognized by present inventors, for efficient and effective protective credit card cover and methods for using them which provide consistency, repeatability, confidentiality, and have a durable lifespan.

There is a need, recognized by the present inventors, for such apparatus and methods in which the protective credit card cover is user friendly, the mechanism is easy to understand, and that a lay user can interpret without the inventor or other expert present.

There is a need, recognized by the present invention, for such a protective credit card system, which is made of cheap material, which can protect against confidential information being stolen.

Protective Credit Card Cover

The Protective Credit Card Cover can receive a credit card or wallet card comprising of a magnetic strip, a credit card number, credit card chip, or security number.

The Protective Credit Card Cover takes a credit card or wallet card and securely wraps around said card and secures the card with a strong adhesive. The adhesive can be tape or other material that causes binding.

The said Cover can protect against confidential information and identity theft by displaying only key information via apertures present to show name and other important information.

In the case that the Protective Credit Card Cover is removed, the owner will easily identify the tampering because the adhesive will become loose or there may be markings on the actual card due to the adhesive leaving marks.

### BRIEF SUMMARY OF THE INVENTION

A protective credit card cover apparatus that hides confidential information in a credit card, but still allows a credit card transaction to commence. The apparatus has a front side that protect a credit card's front side, a back side that protects a credit cards back side. It achieves this by having visible as well as opaque sections. The apparatus has adhesive section or sections that prevent the credit card from falling out of the apparatus and secures the credit card in place.

### BRIEF DESCRIPTION OF THE SEVERAL VIEWS OF THE DRAWING

FIG. 1 illustrates a perspective front view of an embodiment of a Protective Credit Card Cover apparatus.

FIG. 2A illustrates a perspective view of said Protective Credit Card Cover apparatus 100; FIG. 2B illustrates a side perspective view of said Protective Credit Card Cover apparatus.

FIG. 3 illustrates a side perspective view of a credit card and the positioning of a credit card to fit said Protective Credit Card Cover apparatus.

FIG. 4A illustrates a side perspective view of an embodiment of a Protective Credit Card Cover apparatus being folded, and FIG. 4B illustrates a side wireframe perspective view of a Protective Credit Card Cover being folded.

FIG. 5 illustrates a wireframe perspective back view of an embodiment of a Protective Credit Card Cover apparatus after folding.

FIG. 6 illustrates an elevated topside view of an embodiment of a Protective Credit Card Cover.

FIGS. 7A and 7B illustrate a perspective view of the front and back of a Protective Credit Card Cover after a credit card is inserted and the cover is folded around the credit card.

FIG. 8 illustrates an elevated view of an embodiment of a Protective Credit Card Cover showing the front cover with an additional flap for more protection and multiple adhesive sections to secure a credit card or wallet card from falling out.

FIGS. 9A and 9B illustrate an elevated back view of an embodiment of a Protective Credit Card Cover.

FIGS. 10A and 10B illustrate an elevated front view of an embodiment of a Protective Credit Card Cover.

### DETAILED DESCRIPTION OF THE INVENTION

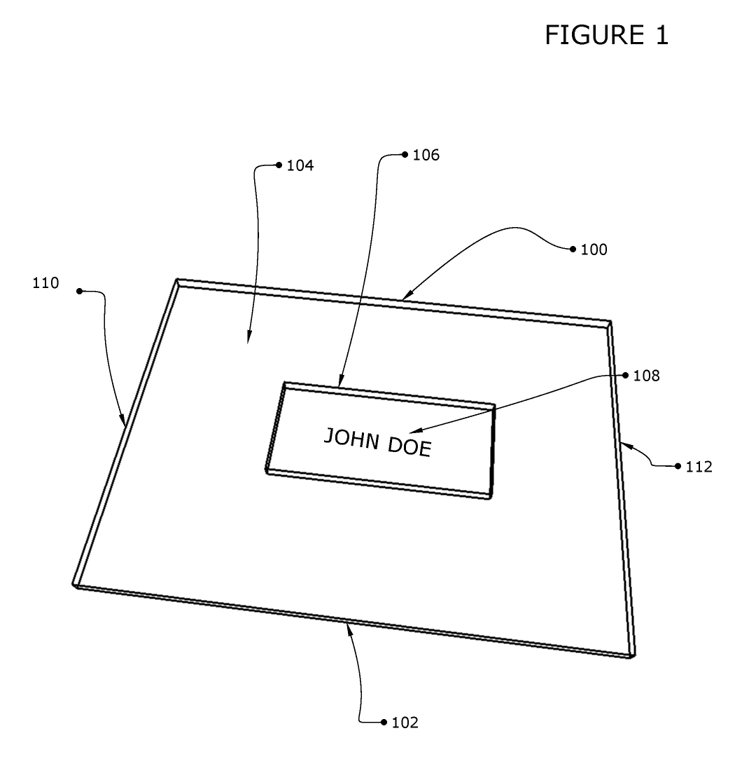

FIG. 1 illustrates a perspective front view of an embodiment of a Protective Credit Card Cover apparatus 100. In one embodiment said Protective Credit Card Cover apparatus can comprise a bottom part 102, a front part 104, an aperture 106, a non-confidential information 108, a left side part 110 and a right side part 112.

In one embodiment said Protective Credit Card Cover apparatus 100 allows a credit card to be placed inside. In one embodiment said Protective Credit Card Cover apparatus 100 securely wraps around a credit card to expose only non-confidential information 108. In one embodiment said Protective Credit Card Cover apparatus 100 securely wraps around a credit card to expose non-confidential information 108. In one embodiment, non-confidential information can be found in a different part of the credit card. In one embodiment, non-confidential information can comprise a magnetic strip, a name, or other information not pertinent to credit card theft. In one embodiment said Protective Credit Card Cover apparatus 100 comprises of paper or plastic. In one embodiment, said Protective Credit Card Cover apparatus 100 can comprise a synthetic paper. In one embodiment, said synthetic paper comprises paper based on filled polyethylene or polypropylene.

In one embodiment said bottom part 102 can be uncovered allowing a credit card or wallet card to be free of an edge covering. In one embodiment, said bottom part 102 can be found on the top of a credit card allowing the top to be uncovered. In one embodiment, said Protective Credit Card Cover apparatus 100 can have an uncovered edge, either on the bottom or the top to allow the magnetic strip on the back side of the credit part to be visible for commerce. In one embodiment said Protective Credit Card Cover apparatus 100 can cover the said front part 104 said left side part 110 and said right side part 112 but not said bottom part 102. In one embodiment, said Protective Credit Card Cover apparatus 100 can leave the bottom part uncovered to expose a magnetic strip as is common on credit cards. In one embodiment said front part 104 can have one or multiple apertures. In one embodiment said aperture 106 can reveal non-confidential information 108 such as name of person, expiration date, or type of card. In one embodiment said side part 110 can wrap behind said front part 104 can cover said left side part 110 and said right side part 112, preventing a credit card from escaping the said Protective Credit Card Cover apparatus 100.

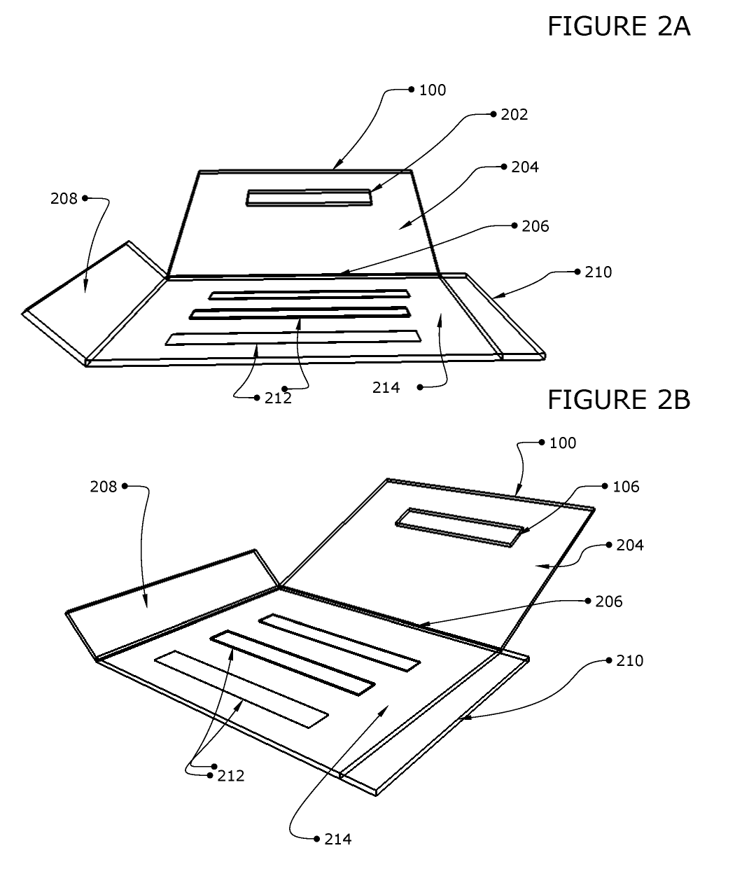

FIG. 2A illustrates a perspective view of said Protective Credit Card Cover apparatus 100; FIG. 2B illustrates a side perspective view of said Protective Credit Card Cover apparatus 100.

FIG. 2A illustrates a perspective view of the said Protective Credit Card Cover apparatus 100. In one embodiment, said Protective Credit Card Cover apparatus 100 comprises a back side 204 of said front side 104, an aperture 106, a vertex 206, a left flap 208, a right flap 210, at least one adhesive section 212, and a second part 214. In one embodiment, said adhesive section 212 can be added to or deleted depending on the level of protection desired and where confidential information can be found on a credit card or wallet card. In one embodiment, said adhesive section 212 can cover all portions of said Protective Credit Card Cover apparatus 100 that does not have an aperture. In one embodiment, said adhesive section 212 can cover all portions of said Protective Credit Card Cover apparatus 100 that does not have non-confidential information.

In one embodiment said Protective Credit Card Cover apparatus 100 comprises a fold or vertex 206 located where said back side 204 is folded toward said second part 214 after a credit card is placed on top of said second part 214 and affixed by a said adhesive section 212 that binds said back side 204 of said front side 104 to said second part 214.

In one embodiment, said adhesive section 212 can comprise of any adhesive. In one embodiment, said adhesive can comprise glue, tape, an adhesive liquid, a viscous solidifying liquid, an adhesive solid, or any material that is used for binding two pieces of matter. Said adhesive 212 can be a commercial grade adhesive as is used and known in the art of binding objects.

In one embodiment, said left flap 208 and said right flap 210 can fold onto said front side 104. In one embodiment, said left flap 208 and said right flap 210 can fold onto said second part 214 followed by said back side of front part 204 folding onto second part. In one embodiment said back side of front part 204 can fold onto said second part 214 followed by said back side of front part 204 folding onto said second part 214. In one embodiment said left flap 208 and said right side 2010 can comprise of an adhesive to attach to said front side 104.

In one embodiment said second part 214 comprises said adhesive 212. In one embodiment said adhesive 212 is used to firmly secure a credit card. In one embodiment, said adhesive 212 is strong enough to deform a credit card if a credit card is removed. In one embodiment, said adhesive 212 can mark a credit card with residue if a credit card is removed from said Protective Credit Card Cover apparatus 100.

FIG. 2B illustrates a side perspective view of said Protective Credit Card Cover apparatus 100. Said FIG. 2B illustrates the folding mechanism for Protective Credit Card Cover apparatus 100 by raising said back side 204 of said front side 104 and folding it onto said second part 214 leaving said front side 104 exposed after the fold. In one embodiment, after said folding, the back side of the front part 204 and second part 214 are no longer completely visible.

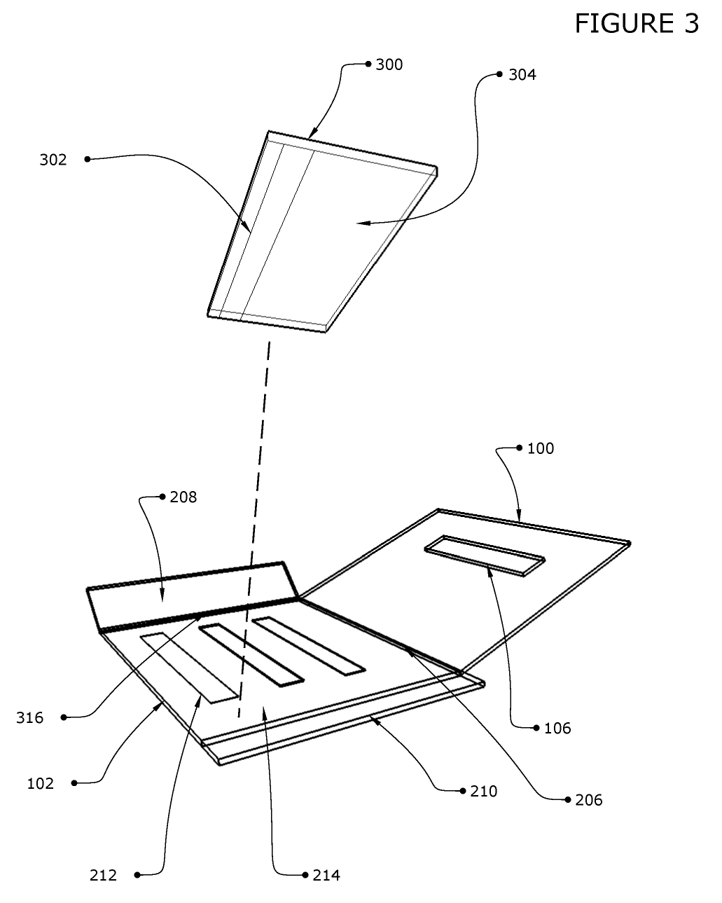

FIG. 3 illustrates a side perspective view of a credit card 300 and the positioning of a credit card to fit said Protective Credit Card Cover apparatus 100. FIG. 3 comprises a credit card 300. In one embodiment, said credit card 300 comprises a magnetic strip 302 and a back side 304. In one embodiment said magnetic strip 302 can be used with a credit card processor or at retail locations to transmit account information to a seller in order to facilitate a transaction. Said magnetic strip 302 is usually swiped to relay account information. In one embodiment, said back side 304 of credit card would be affixed on top of said second part 214 with said magnetic strip 302 closest to said bottom part 102. In one embodiment, said credit card 300 can be affixed by an adhesive material on a said adhesive section 212. After said card is affixed in the said manner, said back side 204 of said front part 104 is folded at said vertex 206 onto said credit card 300. In one embodiment, said left flap 208 and said right flap 210 are folded onto said front part 104. In one embodiment, said folding of left flap 208 or right flap 210, can be a mirror opposite of the left flap 208 folding as can be illustrated by folding said left flap 208 on said second part 214 on a left fold 316. In one embodiment said folding at said left fold 316 can be the mirror opposite of a folding of said right flap 210. In one embodiment, said left flap 208 is folded onto said front part 104 and said right flap 210 is folded onto said front part 104. In one embodiment, said left flap 208 is folded and said right flap 210 is folded then both said left flap 208 and said right flap 210 are attached to said back side 204 of said front side 104. In one embodiment, said right flap 210 and said left flap 208 are attached to said back side 204 of said front side 104 by an adhesive.

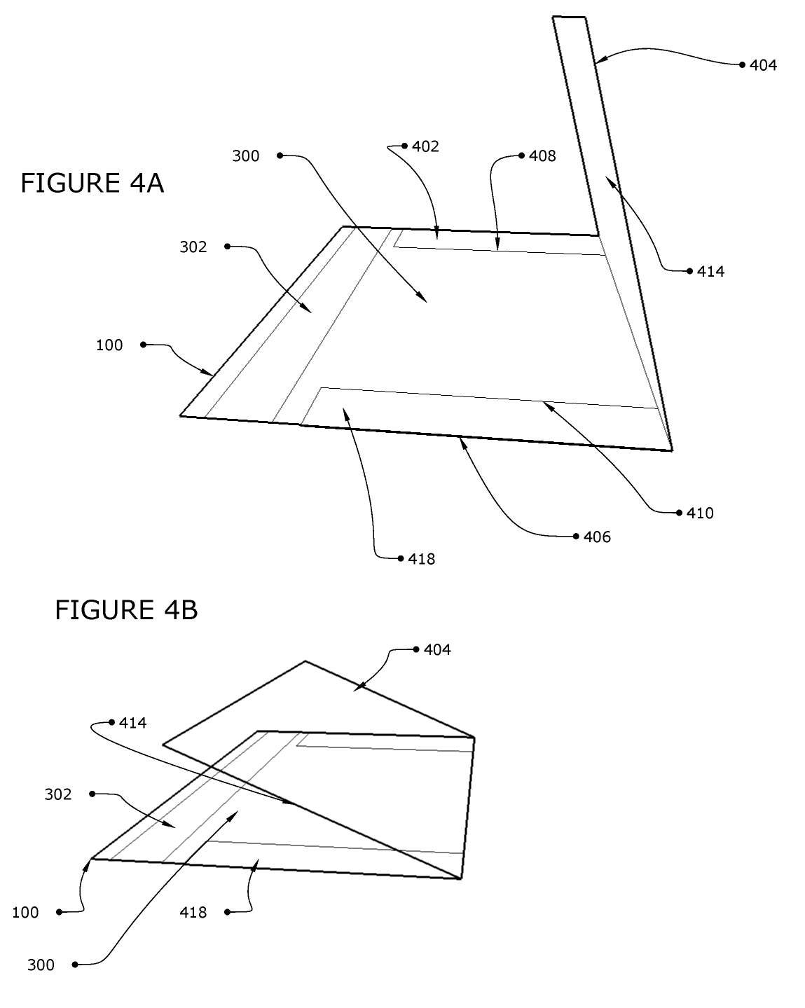

FIG. 4A illustrates a side perspective view of an embodiment of said Protective Credit Card Cover apparatus being folded, and FIG. 4B illustrates a side wireframe perspective view of said Protective Credit Card Cover being folded.

FIG. 4A illustrates a side perspective view of an embodiment of said Protective Credit Card Cover apparatus being folded. Said folding mechanism has a left flap and right flap attached to the front side rather than the second part as shown in FIG. 3. Said FIG. 4A comprises a different embodiment of said Protective Credit Card Cover apparatus 100. In one embodiment said Protective Credit Card Cover apparatus 100 comprises a second part 414, a back side to second part 404, a left side 408, a back side to left side 402, a right side 410, a back side to right side 418. In one embodiment, said left side 408 and said right side 410 fold onto said credit card 300. In one embodiment a fold 406 is created by said right side 410 as shown. A fold can also be present on left side in a similar manner. In one embodiment, said left side 408 and said right side 410 adhere to said credit card 300. In one embodiment, said left side 408 and said right side 410 adhere to said credit card 300 affixing said embodiment of said Protective Credit Card Cover apparatus 100 to said credit card 300. In one embodiment, back side to second part 404 can be affixed with one or many adhesives similar to FIG. 3 to connect the second part 414 of said embodiment of said Protective Credit Card Cover apparatus 100 to a credit card 300. In one embodiment, said back side to second part 404 affixes to said back side to left side 402 and said back side to right side 418 with an adhesive placed on any of said 414, 402, or 408. In one embodiment, said Protective Credit Card Cover apparatus 100 can comprises one adhesive.

FIG. 4B illustrates a side wireframe perspective view of said Protective Credit Card Cover being folded. In one embodiment, after said folding, the credit card 300 is secured and selected confidential information is covered.

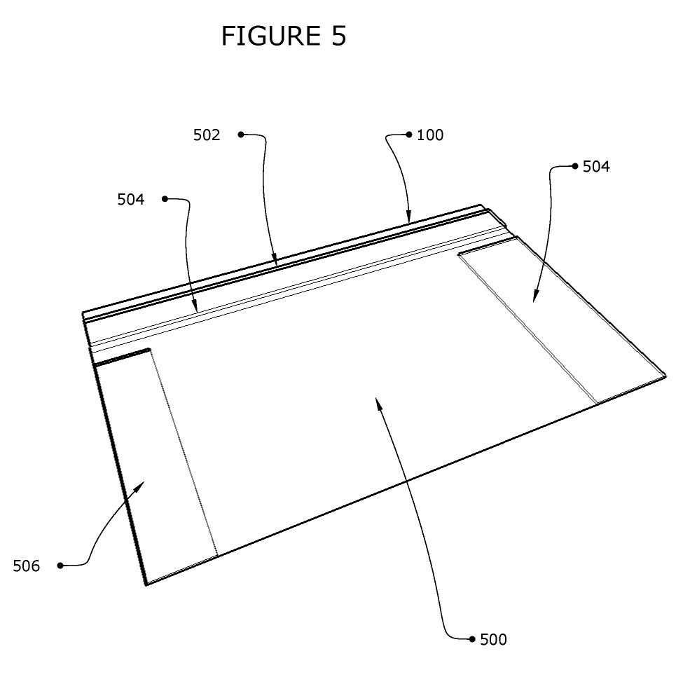

FIG. 5 illustrates a wireframe perspective back view of an embodiment of said Protective Credit Card Cover apparatus 100 after folding. In one embodiment, said Protective Credit Card Cover apparatus 100 comprises a back part 500, a left side flap 504, and a right side flap 506. Said FIG. 5 also comprises a credit card 504, a magnetic strip 502 on said credit card 504. In one embodiment, said back part 500 has a left side flap 504 and a right side flap 506 wrapped around the side of said Protective Credit Card Cover apparatus 100 and affixed on top of said back part 500. In one embodiment, said left side flap 504 and said right side flap 506 are affixed by an adhesive. In one embodiment, said affixed flaps prevent a user from being allowed to see the confidential information. In one embodiment, adhesion can be used to prevent a credit card from becoming detached from said Protective Credit Card Cover apparatus 100.

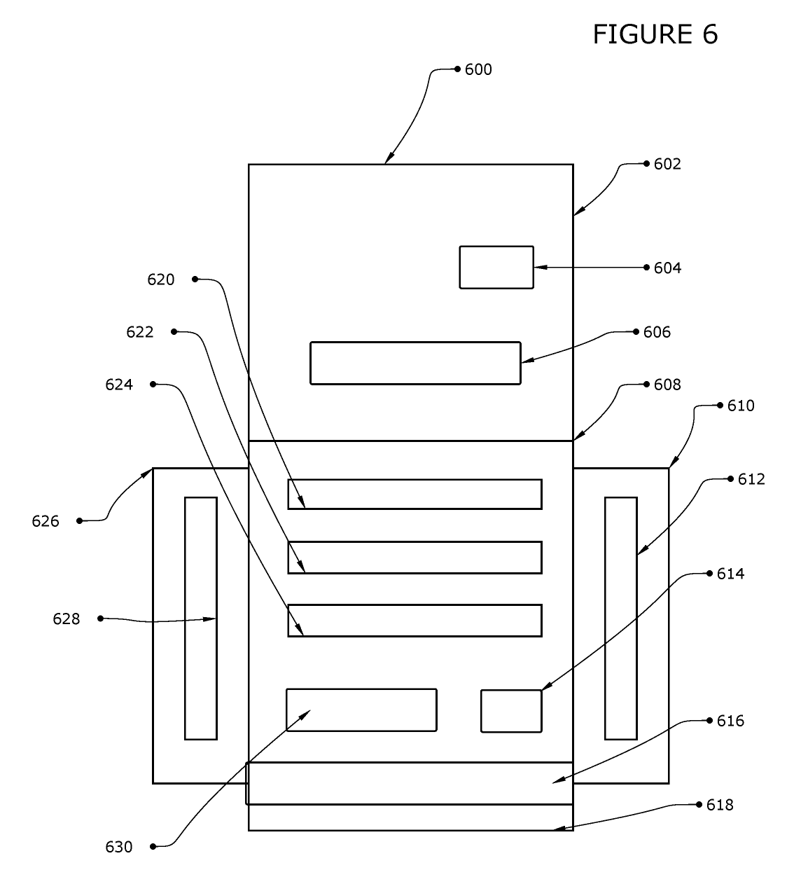

FIG. 6 illustrates an elevated topside view of an embodiment of a Protective Credit Card Cover 600. FIG. 6 illustrates several apertures for non-confidential information and adhesive placements. In one embodiment said Protective Credit Card apparatus 600 comprises a front cover 602. In one embodiment, said front cover 602 is configured for covering a credit card or wallet card's front side. In one embodiment, said front cover 602 comprises an aperture for at least one of: a user's name, credit card number, credit card chip, or expiration date. In one embodiment said front cover 602 comprises the type of card or brand of card being used. In one embodiment, said Protective Credit Card Cover apparatus 600 comprises of a credit card chip aperture 604. Said credit card chip aperture 604 comprises of the ability to read a wallet card or credit card by a wallet card or credit card machine for chip technology. Said chip technology uses a credit card chip to initiate a financial transaction between a user and a merchant. In one embodiment, said Protective Credit Card Cover apparatus 600 comprises an identifying aperture 606 for at least one of: a credit card, wallet card number, or a user's name. Said Protective Credit Card Cover apparatus 600 requires at least one identifying information for a merchant to verify a credit card user or wallet card user's identity. In one embodiment, said identifying aperture 606 can only display a user's name.

In one embodiment, said Protective Credit Card Cover apparatus 600 comprises a back side 618. Said back side 618 comprises an area for the back side of a credit card or wallet card to adhere to. In one embodiment, said back side 618 comprises an area for the magnetic strip of a credit card to be exposed as illustrated by a magnetic strip section 616. Said magnetic strip section 616 can comprise an aperture for a magnetic strip. In one embodiment, said magnetic strip section 616 can comprise of clear plastic that does not impede with transactions between a user and merchant while processing a credit card. In one embodiment, said back side 618 can comprise an aperture for a credit card security code 614 or an aperture for a user's signature block 630. In a transaction between a user and merchant, a merchant may need to compare signatures from the credit card to a user's signature. Further, a merchant may require a user's security code to a credit card to wallet card. Based on this, in one embodiment, said Protective Credit Card Cover apparatus 600 can comprise of apertures for a signature block 630 and a security code 614. In one embodiment, said aperture for said security code 614 can be an aperture for a pin number.

In one embodiment, said Protective Credit Card Cover apparatus 600 comprises a left side panel 626 and a right side panel 610. In one embodiment, said left side panel 626 can comprise a left side panel adhesive 628. In one embodiment, said right side panel can comprise a right panel adhesive 612. In one embodiment, said left side panel 626 and said right side panel 610 affix the back side 618 to the front cover 602 when a fold is made. In one embodiment, said right side panel 610 and said left side panel 626 connect the back side 618 to the front cover 602 by adhesion. In one embodiment, said adhesion can occur after front cover 602 is folded down to back side 618 and said right side panel 610 and said left side panel 626 fold onto the front cover 602 and adhere to the front cover by said right panel adhesive 612 and said left side panel adhesive 628.

In one embodiment, said Protective Credit Card Cover apparatus 600 comprises additional adhesives placed on back side 618. In one embodiment, said back side 618 comprises adhesive sections as illustrated by FIG. 620, 622, or 624. Said adhesive sections 620, 622, and 624 are only shown as examples and other embodiments can comprise of different shapes and sizes. In another embodiment, said adhesive sections 620, 622, and 624 can comprise of only one adhesive. In one embodiment, said adhesive sections 620, 622, and 624 can comprise of double-sided tape. In one embodiment said double-sided tape can comprise a tape with commercial grade adhesion. In another embodiment, said adhesive sections 620, 622, and 624 can comprise of commercial grade adhesives. In another embodiment, said adhesive sections 620, 622, and 624 can comprise glue. In another embodiment, said adhesive sections 620, 622, and 624 can comprise pour-on adhesives. In one embodiment, said front cover 602 can contain adhesive sections to adhere to the front side of a credit card or wallet card in the same manner a credit card is attached to the back side 618 of said Protective Credit Card Cover apparatus 600.

In one embodiment, said right side panel 624 and said left side panel 612 can be of variable length along the back side and can be positioned up or down to best allow for security or utility.

In one embodiment, said right side panel 624 and said left side panel 612 can adhere to the front cover by adhering on the inside of the front cover 602. In another embodiment, said right side panel 624 and said left side panel 612 can adhere to said back side 618.

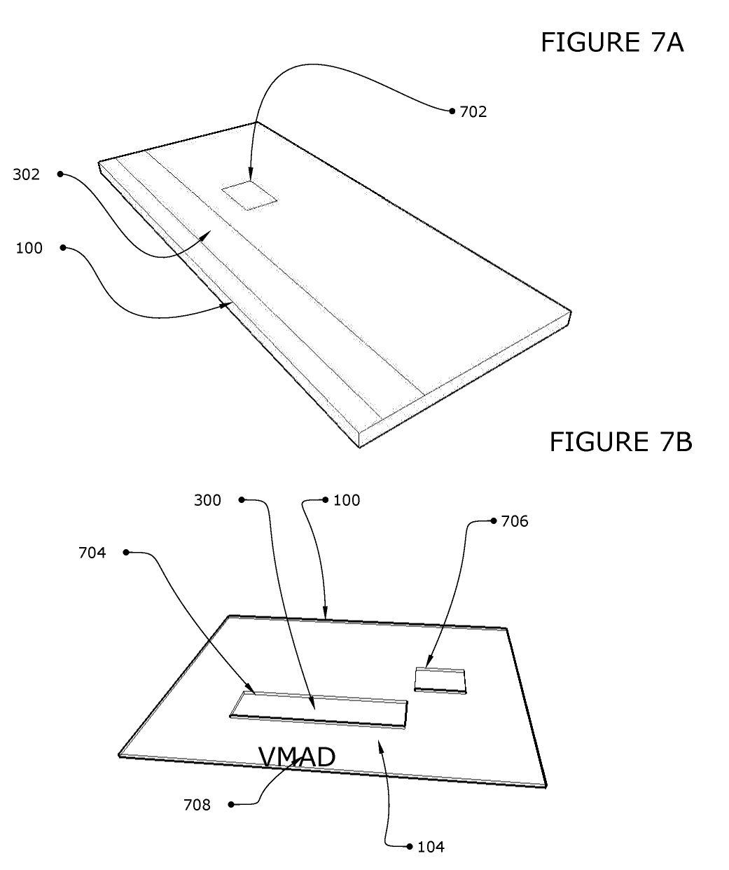

FIGS. 7A and 7B illustrate a perspective view of the front and back of the Protective Credit Card Cover after a credit card is inserted and the cover is folded around the credit card.

FIG. 7A illustrates the perspective back view of an embodiment of said Protective Credit Card Cover apparatus 100 covering a credit card 300. In one embodiment, said Protective Credit Card Cover apparatus 100 comprises a magnetic strip 302 being exposed and an aperture 702 showing a non-confidential information. In one embodiment, said aperture 702 shows a pin number. In one embodiment of said Protective Credit Card Cover apparatus 100, a user can be able to swipe a credit card and ascertain a pin for a credit card; however, confidential information can still be hidden. In one embodiment, said confidential information can be the complete credit card number.

FIG. 7B illustrates the perspective front view of an embodiment of said Protective Credit Card Cover apparatus 100 covering a credit card 300. In one embodiment said Protective Credit Card Cover apparatus 100 comprises a first aperture 704, a second aperture 706, and a text 708. In one embodiment, said first aperture 704 can comprise non-confidential information of a user such as a user's name. In one embodiment, said second aperture 706 can comprise additional information such as a credit card chip. In one embodiment, said credit card chip can be used to facilitate the transaction rather than a magnet strip 302. In one embodiment said text can be one of the following letters v, m, a, or d to show the type of card being used. In one embodiment a v, m, a, d can stand for Visa, Master Card, American Express, or Discover, respectively. In one embodiment, a user can circle a letter in said text 708. In one embodiment, one letter from said text 708 can be printed on said front part 104 of said Protective Credit Card Cover apparatus 100.

FIGS. 7A and 7B illustrate a functioning embodiment of said Protective Credit Card Cover apparatus 100.

Said functioning embodiment allows a user to swipe a credit card while being protected by said Protective Credit Card Cover apparatus 100 or use the card chip to facilitate a transaction without allowing the seller or seller's employee to see confidential information such as a credit card number. A functioning embodiment allows a user to see the magnetic strip and a credit card pin in the back and also the name of the user, a credit card chip, and the type of credit card it is such as a Visa, Master Card, American Express, or Discover.

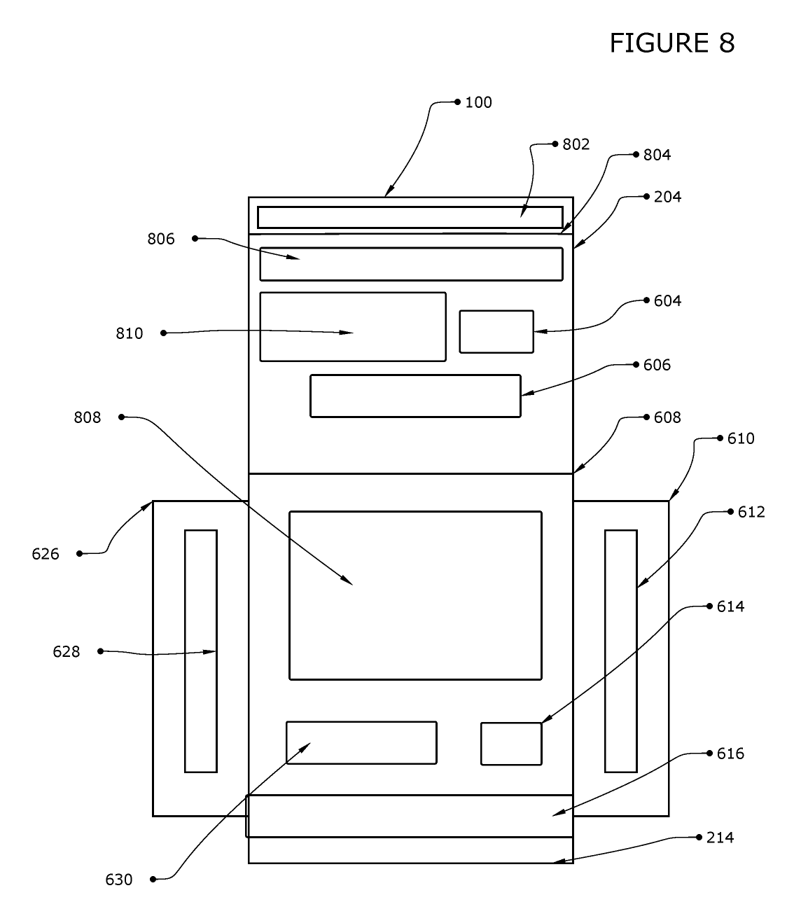

FIG. 8 illustrates an elevated view of an embodiment of said Protective Credit Card Cover 100 showing the front cover with an additional flap for more protection and multiple adhesive sections to secure a credit card or wallet card from falling out. In one embodiment said Protective Credit Card apparatus 100 further comprises a foldable top section of the front cover 804, an adhesive on said top section of the front cover 802, a first adhesive section on the front cover 806, an adhesive section on the back side 808, and a second adhesive section on the front cover 810. Said adhesive sections 806, 808, and 810 adhere to back of said front part 204 and said second part 214 of an embodiment of said Protective Credit Card Cover apparatus 100. In one embodiment, said adhesive sections 806, 808, and 810 can vary in size and shape.

In one embodiment, said Protective Credit Card Cover apparatus 100 comprises a back side of front part 204 with a foldable top section 804. Said foldable top section of front cover 804 can fold to adhere to the other side said second part 214. In one embodiment said foldable top section 804 can be comprised of plastic to allow for the magnetic strip of a credit card to be processed by a credit card processor or machine.

In one embodiment, said Protective Credit Card Cover apparatus 100 can comprise of at least one of a: paper, plastic, and cardboard.

In one embodiment, said Protective Credit Card Cover apparatus 100 can comprise of a material that can be printed allowing users to print designs on said Protective Credit Card Cover.

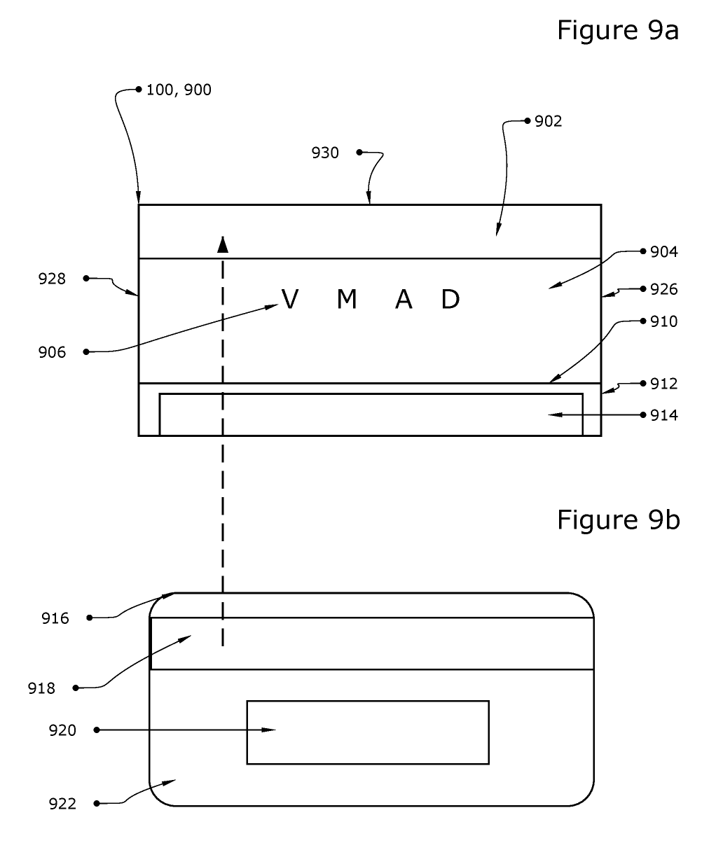

FIG. 9a illustrates an elevated back view of an embodiment of said Protective Credit Card Cover apparatus 100. In one embodiment, said Protective Credit Card Cover apparatus 100 can comprise a back portion 900, a left side 926, a right side 928, a top side 930, an axis 910, a front section of folding part 912, and an adhesive section 914. In one embodiment said back portion 900 can comprise a clear section 902, an opaque section 904, and an alphanumeric 906.

In one embodiment, said Protective Credit Card Cover apparatus 100 can comprise of clear plastic. In one embodiment, said Protective Credit Card Cover apparatus 100 can comprise of opaque sections and visible sections. In one embodiment, said visible sections of said Protective Credit Card Cover apparatus 100 can comprise of plastic.

In one embodiment, said clear section 902 can comprise plastic. In one embodiment, said clear section 902 can comprise any material that allows transmission of information from a credit card's magnetic strip.

In one embodiment, said opaque section 904 can comprise of plastic, paper, or other material that covers information from being visible to a user. In one embodiment, said opaque section 904 can comprise an alphanumeric 906. In one embodiment, said alphanumeric 906 allows a user to distinguish which credit card company issued a credit card. In one embodiment, said opaque section 904 and said Protective Credit Card Cover apparatus 100 can comprise an alphanumeric 906. In one embodiment, said Protective Credit Card Cover apparatus 100 can comprise an alphanumeric 906. In one embodiment, said opaque section 904 can attach or adhere to said Protective Credit Card Cover apparatus 100.

In one embodiment said front section of folding part 912 can comprise a section that folds onto said opaque section 904 along the said axis 910. In one embodiment, said folding of front section of folding part 912 onto said opaque section 904.

In one embodiment said front section of folding part 912 can comprise a section that folds along said axis 910 onto said back portion 900.

In one embodiment, said alphanumeric 906 can comprise one letter or multiple letters. In one embodiment, said alphanumeric can comprise letters, words, or symbols. In one embodiment said alphanumeric 906 can comprise letters or numbers. In one embodiment, said alphanumeric 906 can comprise the letters ‘V’, ‘M’, ‘A’, and ‘D’. In one embodiment, said letters ‘V’, ‘M’, ‘A’, and ‘D’ can represent Visa®, MasterCard®, American Express®, and Discover® respectively.

In one embodiment, said adhesive section 914 is located on said front section of folding part 912. In one embodiment, said adhesive section 914 comprises an adhesive that adheres. In one embodiment, said adhesive can comprise tape, gel, or other adhesives as is known in the art. In one embodiment, said adhesive section 914 comprises an adhesive configured to allow said front section of folding part 912 to adhere. In one embodiment said adhesive section 914 comprises an adhesive that allows said front section of folding part 912 to seal said front section of folding part 912 to said back portion 900.

FIG. 9b represents an elevated of the back of a credit card 916.

In one embodiment, said back of a credit card 916 comprises a magnetic strip 918, confidential information 920, and non-confidential information 922.

In one embodiment, said back of a credit card 916 can comprise a generic credit card back section as is known in the art.

In one embodiment, said magnetic strip 918 contains information to transact monetary business through a credit card as is known in the art.

In one embodiment said confidential information 920 can comprise a user's signature, pin code, and additional user details as is known in the art. In one embodiment, said confidential information 920 can be user information as is found on the back of a credit card. In one embodiment, said confidential information 920 can comprise any information that identifies the user or owner of a credit card.

In one embodiment said credit card 916 can comprise non-confidential information 922. In one embodiment, said non-confidential information 922 can comprise credit card company information. In one embodiment, said non-confidential information 922 can comprise any information that does not identify the user or owner of a credit card.

In one embodiment, said credit card 916 snuggly fits into said Protective Credit Card Cover apparatus 100. In one embodiment said credit card 916 is held in place and prevented from coming out of said Protective Credit Card Cover apparatus 100 by folding of said front section of folding part 912 onto said back portion 900. In one embodiment said credit card 916 is held in place and prevented from coming out of said Protective Credit Card Cover apparatus 100 by folding of said front section of folding part 912 onto said opaque section 904. In one embodiment, a credit card is placed inside said Protective Credit Card Cover apparatus 100 and is secured by said folding of said front section of folding part 912 as to fold on said axis 910 and cover the credit card after the credit card is placed inside of Protective Credit Card Cover apparatus 100, securing said credit card.

In one embodiment, said Protective Credit Card Cover apparatus 100 prevents the disclosure of confidential information while a user or owner is using said credit card 916.

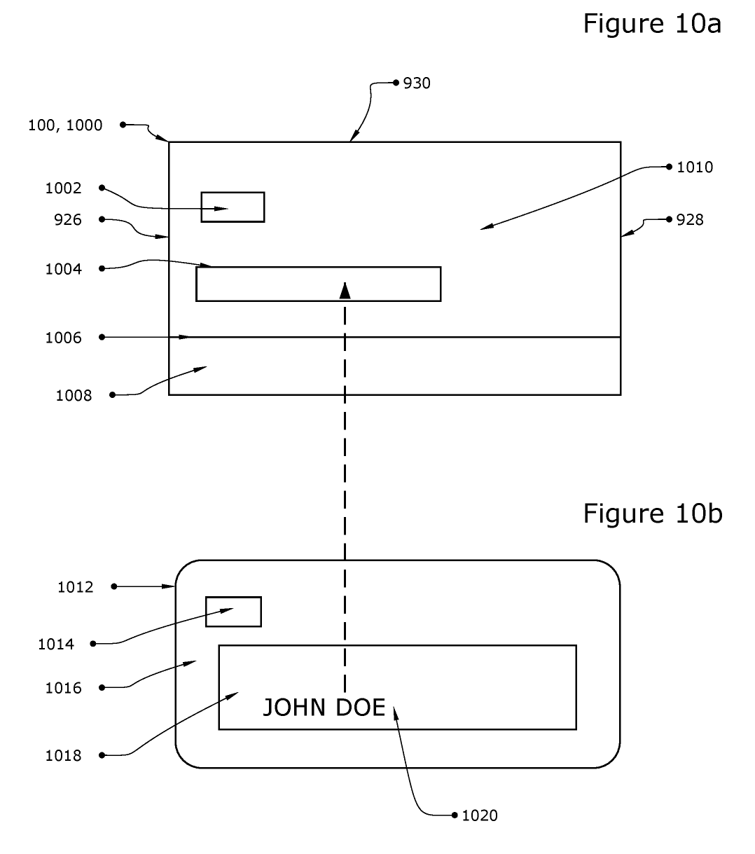

FIG. 10a illustrates an elevated front view of an embodiment of said Protective Credit Card Cover apparatus 100. In one embodiment, said Protective Credit Card Cover apparatus 100 can comprise, a front portion 1000, a left side 926, a right side 928, and a top side 930. Said front portion 1000 can comprise a first section 1002, a second section 1004, an axis 1006, a back section of folding part 1008, and an opaque section 1010.

In one embodiment, said Protective Credit Card Cover apparatus 100 can comprise of clear plastic. In one embodiment, said Protective Credit Card Cover apparatus 100 can comprise of opaque sections and visible sections. In one embodiment, said visible sections of said Protective Credit Card Cover apparatus 100 may comprise of plastic.

In one embodiment, said front portion 1000 can comprise of clear plastic. In one embodiment, said front portion 1000 can comprise of opaque sections and visible sections. In one embodiment, said visible sections of said front portion 1000 can comprise of plastic. In one embodiment, said first section 1002 can comprise an aperture. In one embodiment, said first section 1002 can allow a credit card chip to be visible through the aperture. Said credit card chip is used in credit cards as a new method or apparatus to facilitate a transaction using a credit card in lieu of using a magnetic strip to facilitate a transaction. In one embodiment, said first section 1002 can comprise a plastic section that allows a credit card chip to be visible. In one embodiment, said first section 1002, can comprise a plastic section that allows a credit card chip to facilitate a monetary transaction. In one embodiment, said first section 1002, can comprise a section that allows transmission of selective information.

In one embodiment, said second section 1004 can comprise an aperture. In one embodiment, said second section 1004 can allow a credit card owner's name. In one embodiment, said second section 1004 can comprise a plastic section that allows a credit card owner's name to be visible. In one embodiment, said second section 1004, can comprise a plastic section that allows a credit card owner's confidential information to selectively be visible. In one embodiment, said second section 1004, can comprise a means for a credit card owner's confidential information to selectively be visible.

In one embodiment, said axis 1006 can comprise an axis along which said back section of folding part 1008 may fold toward the back portion 900.

In one embodiment, said back section of folding part 1008 can fold underneath said front portion 1000. In one embodiment, said back section of folding part 1008 can fold onto said back portion 900. In one embodiment, said back section of folding part 1008 can fold onto said opaque section 904 of said back portion 900. In one embodiment, said back section of folding part 1008 can fold onto said opaque section 904 along an axis 910 of said back portion 900.

FIG. 10b represents an elevated view of the front of a credit card 1012.

In one embodiment, said front of a credit card 1012 can comprises a credit card chip 1014, confidential information 1018, and non-confidential information 1016.

In one embodiment, said front of a credit card 1012 can comprise a generic credit card front section as is known in the art.

In one embodiment, said credit card chip 1014 contains information to transact money through a credit card as is known in the art.

In one embodiment said confidential information 1018 can comprise a user's name, credit card number, and additional user details as is known in the art. In one embodiment, said confidential information 1018 can be user information as is found on the front of a credit card. In one embodiment, said confidential information 1018 can comprise any information that identifies the user or owner of a credit card.

In one embodiment said front of a credit card 1012 can comprise non-confidential information 1016. In one embodiment, said non-confidential information 1016 can comprise credit card company information. In one embodiment, said non-confidential information 1016 can comprise any information that does not identify the user or owner of a credit card.

In one embodiment, said front part of credit card 1012 snuggly fits into said front portion 1000. In one embodiment, said credit card 1012 is held in place and prevented from coming out of said Protective Credit Card Cover apparatus 100 by folding of said back section of folding part 1008 onto said back portion 900. In one embodiment, said credit card 1012 is held in place and prevented from coming out of said Protective Credit Card Cover apparatus 100 by folding of said back section of folding part 1008 onto said opaque section 904.

In one embodiment, said Protective Credit Card Cover apparatus 100 prevents the disclosure of confidential information while a user or owner is using said front part of credit card 1012.

In one embodiment said left side 926, said right side 928, and said top side 930 can connect back portion 900 and front portion 1000 by three sides, leaving only an entry for a credit card from the bottom. In one embodiment said left side 926, said right side 928, and said top side 930 can comprise of plastic.

In one embodiment, a credit card fits between said back portion 900 and said front portion 1000, and said credit card is secured in place by said front section of folding part 912, said back section of folding part 1008, and said adhesive section 914.

It is understood that the above-described embodiments are illustrative of only a few of the many possible specific embodiments, which can represent applications of the invention. Numerous and varied other arrangements can be made by those skilled in the art without departing the spirit and scope of the invention.

What is claimed is:

1. A protective credit card cover apparatus that comprises:
a front portion configured to protect confidential information from the front of a credit card wherein the front portion is selectively displaying non-confidential information;
a back portion configured to protect the back of a credit card wherein the back portion is selectively displaying non-confidential information;
a visible portion configured to show selective information;
an opaque portion configured to protect confidential information;
a connecting portion connecting said front portion and said back portion; and
an adhesive portion on connecting portion configured to connect the front portion and back portion configured to allow a credit card to be placed within the credit card protective cover and securely fitted into said protective credit card cover apparatus.

2. The apparatus in claim 1 wherein front portion and back portion are connected by multiple connecting portions.

3. The apparatus in claim 2 wherein said front portion and said back portion are connected by side portions.

4. The apparatus in claim 1 wherein said front portion and back portion are seamlessly connected by three sides.

5. The apparatus in claim 1 wherein the apparatus is made of plastic.

6. The apparatus in claim 1 wherein the visible sections include a credit card chip, a credit card magnetic strip, a user's name, and non-confidential information.

7. The apparatus in claim 1 wherein an opaque section contain alphanumeric characters to symbolize which credit card is in said protective cover for credit cards.

8. protective credit card cover apparatus that comprises:
a front portion configured to protect confidential information from the front of a credit card wherein the front portion is selectively displaying non-confidential information;
a back portion configured to protect the back of a credit card wherein the back portion is selectively displaying non-confidential information;
side portions that are on either side of said front portion and said back portion;
